(19) United States
(12) Patent Application Publication
(10) Pub. No.: US 2016/0232553 A1
(43) Pub. Date: Aug. 11, 2016

(54) APPARATUS AND METHOD FOR SECURE DIGITAL COUPON VERIFICATION

(71) Applicant: Xerox Corporation, Norwalk, CT (US)

(72) Inventors: Sai Praneeth Reddy K, Bangalore (IN); Ishaan Preet Singh, Chandigarh (IN); Shailesh Vaya, Bangalore (IN)

(21) Appl. No.: 14/614,730

(22) Filed: Feb. 5, 2015

(51) Int. Cl. G06Q 30/02

(52) U.S. Cl. CPC G06Q 30/0225; G06Q 2220/00

(57) ABSTRACT

An apparatus, method and non-transitory computer readable medium for verifying a digital coupon are disclosed. For example, the apparatus includes a processor and a computer readable medium storing a plurality of instructions, which when executed by the processor, cause the processor to perform operations for verifying a digital coupon. The operations include generating a profile of attributes and an associated value for each one of the attributes that are allowed to redeem the digital coupon, receiving a request from an endpoint device of a user to redeem the digital coupon with a user profile of attributes of the user and verifying the digital coupon and that the attributes of the user profile match the attributes of the profile that are allowed to redeem the digital coupon, without disclosing each value of each one of the attributes in the profile.

The present disclosure relates generally to generation and verification of digital coupons and, more particularly, to an apparatus and method for secure digital coupon verification.

### BACKGROUND

Every year over 300 billion coupons are distributed world-wide and digital coupons account for up to 20% of these coupons. The use of digital coupons boosts sales for companies. However, digital coupons are also prone to malredemption and misuse. For example, current digital coupons that are intended for one particular user can be easily transferred to another user.

Digital coupons could be personalized to the identity of a single user. However, privacy of the user then becomes a major concern. For example, consumers want to protect their privacy, and generally do not want to share their personal information. Thus, general targeted advertising based on a consumer's sensitive personal information would be insufficient to provide secure digital coupons that are intended to be used by the targeted consumer.

### SUMMARY

According to aspects illustrated herein, there are provided an apparatus, a method and a non-transitory computer readable medium for verifying a digital coupon. One disclosed feature of the embodiments is an apparatus comprises a processor and a computer readable medium storing a plurality of instructions, which when executed by the processor, cause the processor to perform operations for verifying a digital coupon. The operations comprise generating a profile of attributes and an associated value for each one of the attributes that are allowed to redeem the digital coupon, receiving a request from an endpoint device of a user to redeem the digital coupon with a user profile of attributes of the user and verifying the digital coupon and that the attributes of the user profile match the attributes of the profile that are allowed to redeem the digital coupon, without disclosing each value of each one of the attributes in the profile.

Another disclosed feature of the embodiments is a method for verifying a digital coupon comprising generating a profile of attributes and an associated value for each one of the attributes that are allowed to redeem the digital coupon, receiving a request from an endpoint device of a user to redeem the digital coupon with a user profile of attributes of the user and verifying the digital coupon and that the attributes of the user profile match the attributes of the profile that are allowed to redeem the digital coupon, without disclosing each value of each one of the attributes in the profile.

Another disclosed feature of the embodiments is a non-transitory computer-readable medium having stored thereon a plurality of instructions, the plurality of instructions including instructions, which when executed by a processor, cause the processor to perform operations comprising generating a profile of attributes and an associated value for each one of the attributes that are allowed to redeem the digital coupon, receiving a request from an endpoint device of a user to redeem the digital coupon with a user profile of attributes of the user and verifying the digital coupon and that the attributes of the user profile match the attributes of the profile that are allowed to redeem the digital coupon, without disclosing each value of each one of the attributes in the profile.

### BRIEF DESCRIPTION OF THE DRAWINGS

The teaching of the present disclosure can be readily understood by considering the following detailed description in conjunction with the accompanying drawings, in which:

FIG. 1 illustrates an example of a block diagram of a system of the present disclosure;

FIG. 2 illustrates an example of a profile of attributes of the present disclosure;

FIG. 3 illustrates an example binary tree of the present disclosure;

FIG. 4 illustrates a flowchart of one embodiment of a method for verifying a digital coupon; and

FIG. 5 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for verifying a digital coupon. As discussed above, every year over 300 billion coupons are distributed world-wide and digital coupons account for up to 20% of these coupons. The use of digital coupons boosts sales for companies. However, digital coupons are also prone to malredemption and misuse. For example, current digital coupons that are intended for one particular user can be easily transferred to another user.

Embodiments of the present disclosure provide a novel method for verifying a digital coupon to ensure that the user attempting to redeem the coupon is the intended recipient without revealing any personal information about the user. As a result, a retailer may distribute digital coupons that are intended for specific customers or users based on a user profile without accessing any information in the user profile. As a result, even though the user's profile information is used for the verification process, the user's profile information is used in an encrypted form that can never be accessed by the retailer. Thus, the user's privacy is still maintained during the digital coupon verification.

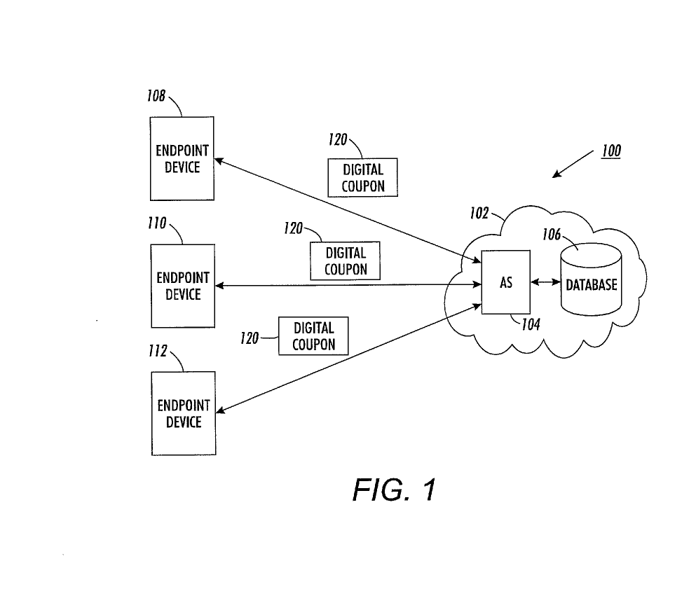

FIG. 1 illustrates an example system 100 of the present disclosure. In one embodiment, the system 100 includes a communications network 102, an application server (AS) 104 and a database (DB) 106. In one embodiment, the communications network 102 may be any type of communications network including, for example, an Internet Protocol (IP) network, a cellular network, a broadband network, and the like.

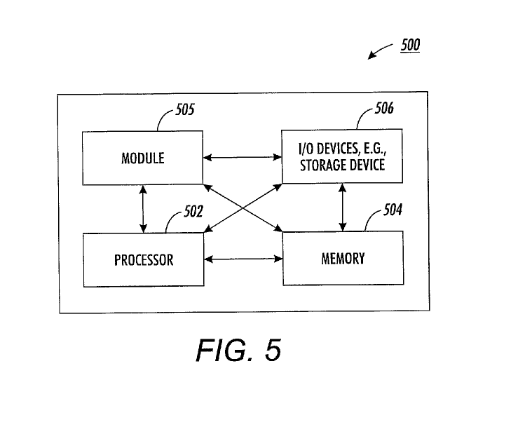

In one embodiment, the AS 104 may be deployed as a dedicated computer for performing the functions described herein and described below in FIG. 5. The DB 106 may store various information such as attributes of a profile associated with a digital coupon, digital coupons that are generated by a retailer, encryption algorithms used herein, binary trees that are generated for the digital coupon verification, and the like.

In one embodiment, one or more endpoint devices 108, 110 and 112 may be in communication with the communication network 102. The one or more endpoint devices 108, 110 and 112 may be any type of endpoint devices, such as for example, a desktop computer, a laptop computer, a tablet computer, a smart phone, and the like.

It should be noted that FIG. 1 is a block diagram that has been simplified. The system 100 may include other network elements and access networks not shown. For example, the communication network 102 may include other network elements such as a firewall, border elements, gateways, and the like. The communication network 102 may also have additional access networks between the one or more endpoint devices 108, 110 and 112 and the network 102, such as for example, a cellular access network, a broadband access network, and the like.

In one embodiment, the AS 104 and the DB 106 may be operated by a retailer that generates digital coupons to promote sales and marketing. The retailer may generate one or more digital coupons 120 that are targeted for particular users (e.g., users of endpoint devices 108, 110 and 112). In one embodiment, the digital coupons 120 may be associated with one or more attributes of a profile such that the digital coupons 120 can only be redeemed by the targeted user. In other words, digital coupons 120 cannot be distributed by an intended user to other users that do not have the matching attributes of the profile associated with the digital coupons 120. Furthermore, when the digital coupon 120 is redeemed by a targeted user, the digital coupon 120 may be verified by checking to see if the attributes of the targeted user match the attributes of the profile of a targeted user and associated with the digital coupon 120.

In one embodiment, the verification is performed without revealing any information within the user profile of the user to the AS 104 or retailer. Thus, the privacy of each user is maintained even though the attributes of the user's profile is used to verify the digital coupon.

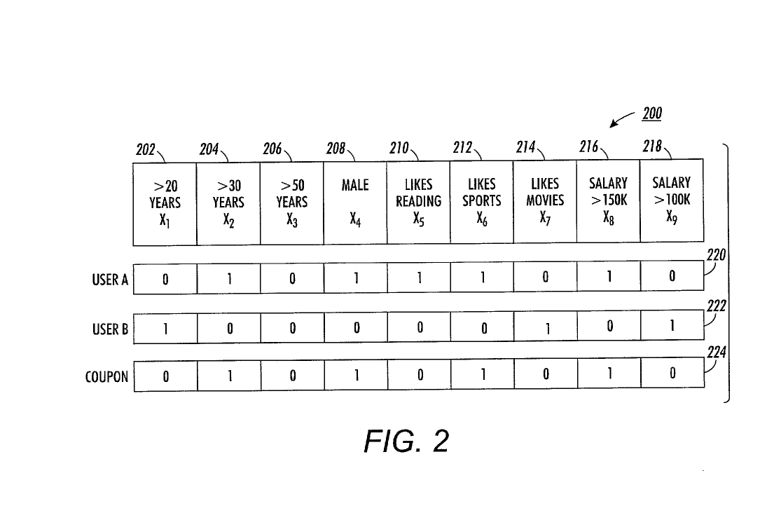

FIG. 2 illustrates an example profile 200 with one or more attributes 202-218. For example, the attributes may include an older than 20 attribute 202, an older than 30 attribute 204, an older than 50 attribute 206, a male attribute 208, a likes reading attribute 210, a likes sports attribute 212, a likes movies attribute 214, a salary greater than $150K attribute 216 and a salary greater than $100K attribute 218. It should be noted that attributes 202-218 are only examples and the profile 200 may include more attributes, less attributes and different categories of attributes.

In one embodiment, each one of the attributes 202-218 may have a value. In one embodiment, the value may be either 0 or 1. For example, if the attribute is true, the value of the attribute may be 1 and if attribute is not true, the value of the attribute may be 0. For example, if the user is a female, the attribute 208 would have a value of 0.

In one embodiment, the retailer may generate a digital coupon 120 that includes a subset of all of the attributes illustrated in profile 224. For example, the retailer may want to generate a coupon 120 that is targeted for a user that is older than 30 years old, male, like sports and has a salary greater than $150K. Thus, the profile 224 for the digital coupon 120 may have a value of 1 for the attributes 204, 208, 212 and 216. The remaining attributes may have a value of 0 or be considered as “don't cares.”

In one embodiment, the digital coupon 120 may be distributed to the public and user A and user B may find the digital coupon 120. The user A may have a user profile 220 and the user B may have a user profile 222. The user A may attempt to redeem the digital coupon 120 with the retailer and the AS 104 may verify that the user A has attributes in the user profile 220 that match the attributes in the profile 224 associated with the digital coupon 120 without knowing the value of the attributes in the user profile 220 (as will be discussed below). Thus, the user A may be allowed to redeem the digital coupon 120.

The user A may feel that the digital coupon 120 is a great deal and forward the digital coupon 120 to a friend, user B. The user B may also try to redeem the digital coupon 120. However, attributes of a user profile 222 of the user B may not match the attributes of the profile 224 associated with the digital coupon 120 and the user B may be denied from redeeming the digital coupon 120.

In one embodiment, the user profiles 220 and 222 may be generated by each user on his or her respective endpoint device 108, 110 or 112. In one embodiment, the user profiles 220 and 222 may be generated by answering a questionnaire or based on monitoring the user's habits on his or her respective endpoint device 108, 110 or 112. For example, the retailer may allow the user to download a client to operate on the endpoint device 108, 110 or 112 that monitors the user's activity in exchange for the targeted digital coupons 120.

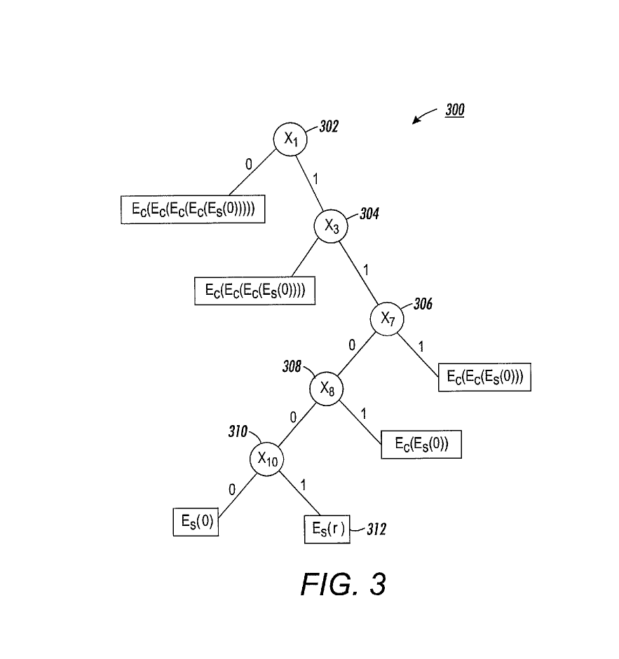

In one embodiment, the digital coupon 120 may be verified by the AS 104 without accessing the actual values within the attributes of the user profiles, as discussed above. To perform this verification, in one embodiment, the retailer may generate a plurality of binary trees for each digital coupon and each acceptable profile of attributes. FIG. 3 illustrates an example of a binary tree 300.

In one embodiment, each node 302, 304, 306, 308 and 310 may represent an attribute of a profile (e.g., one or more of the attributes 202-218 of the profile 200). In one embodiment, the binary tree may be generated where each node 302, 304, 306, 308 and 310 may get inputs as the value of an attribute of the user's profile that is encrypted with a homomorphic encryption scheme using a private key from a user. For example, the private key may be exchanged with the user when the user installs the client on his or her endpoint device and sets up his or her user profile. In addition, each node 302, 304, 306, 308 and 310 may have a leaf node that is an encryption of 0 that is encrypted using an encryption key of the retailer shown as Eₛ(0) in FIG. 3. In one embodiment, the encryption of 0 for each node from the bottom node 310 to the top node 302 will be an encryption using the private key from the user of the encryption using the public encryption key of the retailer (e.g., E_{c}(Eₛ(0)) at node 308 to E_{c}(E_{c}(E_{c}(E_{c}(Eₛ(0))))) at node 302). As a result, when the user receives the encrypted value, as discussed below, the endpoint device of the user will know how many times to decrypt the encrypted value. In one embodiment, the homomorphic encryption scheme may be a Length Flexible Additively Homomorphic (LFAH). Since the binary tree 300 is generated using the user's private key, the retailer or the AS 104 cannot decrypt the value of each node 302-310 or access the value of each attribute of the user.

In one embodiment, the LFAH encryption scheme is a tuple Π=(G, E, D), where G is a generating algorithm, E is a randomized encryption algorithm and D is a decryption algorithm. E and D additionally take a length parameter I, with E encrypting plain texts ∈ 55 0, 1}^{l}. In one embodiment, the encryption and decryption scheme may be a Damgard Junk crypto system.

In one embodiment, the computation at each node 302, 304, 306, 308 and 310 may be based off of (but not identical to) a computationally private information retrieval (CPIR) protocol that may be applied to each node 302, 304, 306, 308 and 310 of the binary tree 300. For each node 302, 304, 306, 308 and 310, a correct answer will lead to an encryption of the value of the next node. An incorrect answer will lead to an encryption of 0. Each node is computed using a CPIR like function until a top most node is reached (e.g., node 302) that leads to an encryption of a random number in the node 302. For example, the computation may begin with the node 310 and a correct answer will lead to an encryption of a random number 312 that is used for the node 310 such that the value of the node 308 can be computed, and so forth up to the encryption of the random number in the node 302.

In one embodiment, the above computation is similar to a CPIR protocol such as a simple primitive for a 2-1 computationally private information retrieval protocol in a client server model. The server has 2 values f₀ and f₁ (each l bits long), while the client has a bit b. The CPIR protocol enables the client to learn f_{b} without the server learning b. The client sets its (sk,pk) and sends c=Eₚₖ(l, b) and pk to the server, where sk, pk are the secret key of the client and the public key of the client, respectively. The server replies with R=Eₚₖ(l, f₀)·c^{f}^{₁}^{-d}^{₀}. The client computes Dₛₖ(l,R)=f_{b} expanded on this to create an n−1 CPIR protocol using binary decision diagrams (e.g., the binary tree 300) that is similarly applied to verify the profile of the user. This concept is expanded upon to the entire binary tree 300 described above. In other words, the actual value of each node is not revealed to the server, but encrypted version of the value may be revealed, which may then be sent to the endpoint device of the user to be decrypted.

When a user wishes to redeem the digital coupon 120, the user may send the digital coupon 120 with his or her user profile encrypted bit by bit using the LFAH encryption scheme. The retailer may then compute each node of the binary tree of the user's profile sent by the user using the CPIR protocol to obtain an encryption of a random number based on the user's profile. The retailer may then send the encryption of the random number back to the endpoint 108, 110 or 112 of the user.

The user may then decrypt the encrypted random value or values using the private encryption key of the user at his or her endpoint device 108, 110 or 112 until the value is just an encryption under the public key of the retailer. The user may multiply together each random value that is decrypted. The value may then be raised to a power of a random number to generate an overall random value and sent back to the retailer.

The retailer may decrypt the appropriate binary tree 300 using the encryption key of the retailer to obtain a random value of the binary tree 300 of attributes of an acceptable profile for the digital coupon 120. If the overall random value is a multiple of the random value (e.g., 144 and 12) of the binary tree 300, then there is a match and the user may be verified as an acceptable user. However, if the random value is not an even multiple of the random value (e.g., 143 and 12), then there is not a match and the retailer gets a 0 value, then the user may not be verified as an acceptable user.

In one embodiment, the above high level description may be mathematically set up with initial inputs of a retailer R generating a list of digital coupons cᵢ and the corresponding hash values and a set of t accepted profiles. The user, U, has a hashed coupon code that was received and a profile vector a_{1,}a₂, . . . , aₙ denoting the attributes. R learns whether U's profile is eligible for that particular coupon code without learning anything else about the vector. U learns nothing about R's input other than whether the vector matches or not.

Corresponding to each coupon code cᵢ the retailer stores the hash values of i used as coupon codes and their corresponding validity dates, if any. Every coupon has a set of t accepted profiles for which R creates t binary trees as follows:

R chooses a u bit random number r.

R sets up a Public Key LFAH with public key s.

For each profile attributes pair (pas, val) the retailer creates a binary tree (e.g., the binary tree 300). The tree is created such that as one traverses downwards from the root node (e.g., the node 302), choosing the right child if the bit xᵢ is 1 and the left child if the bit is 0, Eₛ(r) should be reached. Continuing similarly along all vectors other than val should lead to a leaf node of 0. Thus, the retailer creates t binary trees of depth k for each coupon.

The user sets up a Damgard Jurik cryptosystem using the generating algorithm G with public key pk and secret key sk. The user encrypts each bit of the user's profile and sends pk, Eₚₖ(l, a₁), Eₚₖ(l, a₂), . . . , Eₚₖ(l, aₙ) with the length parameter s+k such that s is the smallest number satisfying 2^{l}≦n^{s} given l is the minimum length parameter of the encryption of a u bit number under the server's key.

The retailer encrypts leaf nodes at j^{th} levels (assuming the root node is at level 0) under pk, k−j times using length parameter l in the first encryption and then increasing the size parameter (s in n^{s} by one each time).

The retailer uses the compression function C to change the length of the encrypted bits to the required length for their corresponding levels for every tree. The encryption of a bit at level j is converted to an encryption using a size parameter s′+1 where s′ is the size parameter used to encrypt the node's children.

The retailer now uses the computation from the CPIR protocol as follows. The length parameter is not mentioned, but is implicit from the descriptions below. At the lowest internal node (xᵢₖ), the retailer computes Eₚₖ(0)·Eₚₖ(xᵢₖ)^{E}^{ₛ}^{(r)-E}^{ₚₖ}(0). The retailer replaces the internal node with a leaf node containing this computed value. The retailer repeats the above steps at the now lowest level and continues until the retailer computes the root node's output.

The retailer sends the output of each tree to the user. The user decrypts each k times yielding Eₛ(0|r). The user takes the product of all these terms and raises it to a random number r₂ of length u−length(t)−1 obtaining Eₛ (number of matched profiles*r*r₂) and sends this back to the retailer. For example, if the encryption of 0 was received, 0 raised to any power would still result in 0 indicating that there was a mismatch that the user is not verified to use the coupon. However, if the encryption of a random number was received, the random number raised to a power would result in a multiple of the random number indicating that the user is verified to use the coupon. In addition, the encryption of the random number returned to the retailer is raised to a power of another random number so that the retailer does not know how many of the binary trees matched the attributes of the user's profile (e.g., the value of k)

The retailer decrypts the message and accepts the coupon if the decrypted number is divisible by r, rejecting it otherwise.

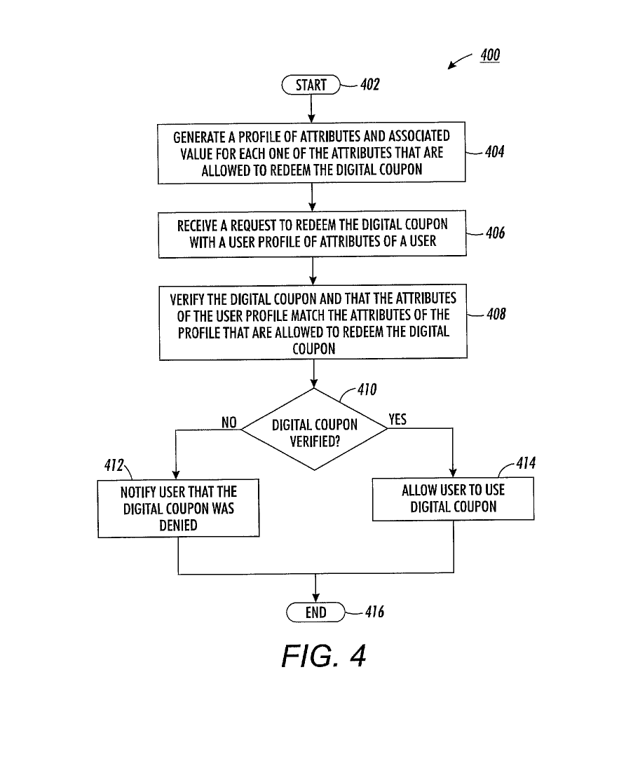

FIG. 4 illustrates a flowchart of a method 400 for verifying a digital coupon. In one embodiment, one or more steps or operations of the method 400 may be performed by the AS 104 or a computer as illustrated in FIG. 5 and discussed below.

At step 402 the method 400 begins. At step 404, the method 400 generates a profile of attributes and an associated value for each one of the attributes that are allowed to redeem the digital coupon. In one embodiment, the attributes that are allowed to redeem the digital coupon may be used to generate one or more binary trees for each set of attributes that are allowed to redeem each digital coupon that is generated.

At step 406, the method 400 receives a request to redeem the digital coupon with a user profile of attributes of a user. For example, the user may send the user's profile encrypted using an LFAH encryption scheme along with the digital coupon.

At step 408, the method 400 verifies the digital coupon and that the attributes of the user profile match the attributes of the profile that are allowed to redeem the digital coupon. The verification may be performed without disclosing each value of each one of the attributes in the user's profile that is sent to the retailer for verification, as described above.

In one embodiment, the verification may include generating a binary tree, where each node of the binary tree takes as an encryption of a value of each attribute from the user's profile that is encrypted with a private key sent from the user. Each node of the binary tree may be traversed from a bottom most node to a top most node that leads to an encrypted random value, using the CPIR-like computation scheme. The encrypted random value for the binary tree may be obtained. The encrypted random value may be transmitted to an endpoint device of the user. Then a random value may be received from the endpoint device of the user that is based on a decryption of the encrypted random value by the endpoint device of the user. The digital coupon may then be verified if the random value matches the encrypted random value or if the random value is a multiple of the encrypted random value indicating that the attributes of the user profile match the attributes of the profile that are allowed to redeem the digital coupon.

At step 410, the method 400 determines if the digital coupon is verified. If the method 400 determines that the digital coupon is not verified, the method 400 may proceed to step 412. At step 412, the method 400 notifies the user that the digital coupon was denied. The method 400 then proceeds to step 416.

Referring back to step 410, if the digital coupon is verified, the method 400 proceeds to step 414. At step 414, the method 400 allows the user to redeem the digital coupon. For example, the transaction may proceed with a discount in accordance with the digital coupon. The method 400 then proceeds to step 416. At step 416, the method 400 ends.

As a result, the embodiments of the present disclosure improve the functioning of an application server or a computer. For example, secure coupons may be generated by the computer and verified by the computer that could not otherwise be generated and securely verified without the improvements provided by the present disclosure. In other words, the technological art of secure digital coupon verification is improved by providing a computer that is modified with the ability to automatically generate secure coupons and verify the secure coupons, as disclosed by the present disclosure.

It should be noted that although not explicitly specified, one or more steps, functions, or operations of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 4 that recite a determining operation, or involve a decision, do not necessarily require that both branches of the determining operation be practiced. In other words, one of the branches of the determining operation can be deemed as an optional step.

FIG. 5 depicts a high-level block diagram of a computer that can be transformed to into a machine that is dedicated to perform the functions described herein. Notably, no computer or machine currently exists that performs the functions as described herein. As a result, the embodiments of the present disclosure improve the operation and functioning of the computer to verify a digital coupon, as disclosed herein.

As depicted in FIG. 5, the computer 500 comprises one or more hardware processor elements 502 (e.g., a central processing unit (CPU), a microprocessor, or a multi-core processor), a memory 504, e.g., random access memory (RAM) and/or read only memory (ROM), a module 505 for verifying a digital coupon, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method(s) as discussed above is implemented in a distributed or parallel manner for a particular illustrative example, i.e., the steps of the above method(s) or the entire method(s) are implemented across multiple or parallel computers, then the computer of this figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 505 for verifying a digital coupon (e.g., a software program comprising computer-executable instructions) can be loaded into memory 504 and executed by hardware processor element 502 to implement the steps, functions or operations as discussed above in connection with the exemplary method 400. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for verifying a digital coupon (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus for verifying a digital coupon, comprising:
a processor; and
a computer-readable medium storing a plurality of instructions, which when executed by the processor, cause the processor to perform operations, the operations comprising:
generating a profile of attributes and an associated value for each one of the attributes that are allowed to redeem the digital coupon;
receiving a request from an endpoint device of a user to redeem the digital coupon with a user profile of attributes of the user; and
verifying the digital coupon and that the attributes of the user profile match the attributes of the profile that are allowed to redeem the digital coupon, without disclosing each value of each one of the attributes in the profile.

2. The apparatus of claim 1, wherein the user profile of attributes is encrypted with a private key of the user.

3. The apparatus of claim 1, wherein the verifying further comprises:
generating a binary tree, wherein each node of the binary tree has an input of a value of an attribute of the profile of attributes of the user that is encrypted with a private key sent by the user, wherein traversing from a bottom most node to a top most node leads to an encrypted random value;
computing a value of the each node of the binary tree using a value of a previous node that was computed;
obtaining the encrypted random value for the binary tree;
transmitting the encrypted random value to the endpoint device of the user;
receiving a random value from the endpoint device of the user that is based on a decryption of the encrypted random value by the endpoint device of the user; and
verifying the digital coupon and that the attributes of the user profile match the attributes of the profile that are allowed to redeem the digital coupon when the random value is a multiple of the encrypted random value.

4. The apparatus of claim 3, wherein the binary tree is encrypted using a homomorphic encryption scheme.

5. The apparatus of claim 4, wherein the homomorphic encryption scheme comprises a Length Flexible Additively Homomorphic (LFAH) encryption scheme.

6. The apparatus of claim 3, wherein the computing is performed on the binary tree using a computation that is based on a computationally private information retrieval (CPIR) protocol.

7. The apparatus of claim 3, wherein the encrypted random value is obtained from the computing the value of the each node correctly until a top most node of the binary tree.

8. The apparatus of claim 1, wherein the profile of attributes includes less attributes than all available attributes of an attribute vector.

9. The apparatus of claim 1, wherein the associated value for the each one of the attributes is 0 or 1.

10. A method for verifying a digital coupon, comprising:
generating, by a processor, a profile of attributes and an associated value for each one of the attributes that are allowed to redeem the digital coupon;
receiving, by the processor, a request from an endpoint device of a user to redeem the digital coupon with a user profile of attributes of the user; and
verifying, by the processor, the digital coupon and that the attributes of the user profile match the attributes of the profile that are allowed to redeem the digital coupon, without disclosing each value of each one of the attributes in the profile.

11. The method of claim 10, wherein the user profile of attributes is encrypted with a private key of the user.

12. The method of claim 10, wherein the verifying further comprises:
generating, by the processor, a binary tree, wherein each node of the binary tree has an input of a value of an attribute of the profile of attributes of the user that is encrypted with a private key sent by the user, wherein traversing from a bottom most node to a top most node leads to an encrypted random value;
computing, by the processor, a value of the each node of the binary tree using a value of a previous node that was computed;
obtaining, by the processor, the encrypted random value for the binary tree;
transmitting, by the processor, the encrypted random value to the endpoint device of the user;
receiving, by the processor, a random value from the endpoint device of the user that is based on a decryption of the encrypted random value by the endpoint device of the user; and
verifying, by the processor, the digital coupon and that the attributes of the user profile match the attributes of the profile that are allowed to redeem the digital coupon when the random value is a multiple of the encrypted random value.

13. The method of claim 12, wherein the binary tree is encrypted using a homomorphic encryption scheme.

14. The method of claim 13, wherein the homomorphic encryption scheme comprises a Length Flexible Additively Homomorphic (LFAH) encryption scheme.

15. The method of claim 12, wherein the computing is performed on the binary tree using a computation that is based on a computationally private information retrieval (CPIR) protocol.

16. The method of claim 12, wherein the encrypted random value is obtained from the computing the value of the each node correctly until a top most node of the binary tree.

17. The method of claim 10, wherein the profile of attributes includes less attributes than all available attributes of an attribute vector.

18. The method of claim 10, wherein the associated value for the each one of the attributes is 0 or 1.

19. A method for verifying a digital coupon, comprising:
generating, by a processor, a profile of a subset of attributes from all available profile attributes and an associated value for each one of the subset attributes that are allowed to redeem the digital coupon;
generating, by the processor, a binary tree, wherein each node of the binary tree has an input of an associated value for each one of the subset of attributes, wherein traversing from a bottom most node to a top most node leads to an encrypted random value;
receiving, by the processor, a user profile of attributes that is encrypted with a private key;
computing, by the processor, a value of the each node of the binary tree using a value of a previous node that was decrypted;
obtaining, by the processor, the encrypted random value for the binary tree;
transmitting, by the processor, the encrypted random value to an endpoint device of a user;
receiving, by the processor, a random value from the endpoint device of the user that is based on a decryption of the encrypted value by the endpoint device of the user;
verifying, by the processor, the digital coupon and that the attributes of the user profile match the attributes of the profile that are allowed to redeem the digital coupon when the random value is a multiple of the encrypted random value.

20. The method of claim 19, wherein the binary tree is encrypted using a homomorphic encryption scheme.
